(19) United States
(12) Patent Application Publication
(10) Pub. No.: US 2013/0258044 A1
(43) Pub. Date: Oct. 3, 2013

(54) MULTI-LENS CAMERA

(71) Applicant: Jonathan N. Betts-Lacroix, Belmont, CA (US)

(72) Inventor: Jonathan N. Betts-Lacroix, Belmont, CA (US)

(73) Assignee: ZETTA RESEARCH AND DEVELOPMENT LLC - FORC SERIES, Wilmington, DE (US)

(21) Appl. No.: 13/435,549

(22) Filed: Mar. 30, 2012

(51) Int. Cl. H04N 5/33; H04N 5/228; B23Q 17/00; H04N 5/76

(52) U.S. Cl. 348/36; 348/231.99; 348/164; 29/407.01; 348/E17.002; 348/E05.09

(57) ABSTRACT

A camera with multiple lenses and multiple sensors wherein each lens/sensor pair generates a sub-image of a final photograph or video. Different embodiments include: manufacturing all lenses as a single component; manufacturing all sensors as one piece of silicon; different lenses incorporate filters for different wavelengths, including IR and UV; non-circular lenses; different lenses are different focal lengths; different lenses focus at different distances; selection of sharpest sub-image; blurring of selected sub-images; different lens/sensor pairs have different exposures; selection of optimum exposure sub-images; identification of distinct objects based on distance; stereo imaging in more than one axis; and dynamic optical center-line calibration.

### FIELD OF THE INVENTION

The field of this invention is cameras. More specifically, the field of this invention is cameras with multiple lenses.

### BACKGROUND OF THE INVENTION

A traditional camera consists of one lens and one generally planer image receiving area. For many years, the image receiving area has comprised photosensitive film. In more recent years, most cameras have used an electronic image sensor, such as CCD or CMOS sensors. These sensors are traditionally rectangular, often having an aspect ratio of about 4:5 or 4:6. Common sensor sizes include: 35 mm “full frame,” APS-H, APS-C, “Four Thirds,” 1/1.6, 1/1.8, and 1/2.5 inch, and many others.

Lenses for the simplest of cameras may be a single element of glass or plastic. Lenses for most cameras consist of multiple elements to reduce the various distortions and aberrations caused by a single lens.

The cost of manufacturing lenses rises at the rate of at least the cube of the diameter of the lens since the volume of the lens elements goes up as the cube of the diameter. In addition, smaller lenses are sold and manufactured in higher volume than large lenses, so economies of scale add to the cost difference between small and large lenses.

An article in Wikipedia.org in 2011 said that the production cost of a full frame sensor can exceed the cost of an APC-C sensor by a factor of 20. The area sizes for the two sensors (full-frame v. APC-C) are approximately 370 square mm and 864 square mm, respectively, for a sensor area ratio of 2.34. Thus a factor of 20 in price buys a factor of 2.34 in area increase.

The light gathering capacity of a lens goes up approximately as the square of the diameter, assuming the lens is appropriately matched to an equivalent sized image sensor. Thus, the cost of optics goes up as the cube of the diameter while the light gathering ability goes up as the square. Based solely on these mathematical relationships a camera built out of many low cost, small diameter lens/sensor pairs should either be lower cost than a single lens/sensor camera with comparable light-gathering ability or alternatively have more light-gathering ability that a single lens/sensor camera of comparable cost.

Typically, as of the filing date of this application, a camera includes a three color filter precision placed over the sensor to generate separate data for red, green, and blue light. A disadvantage of this filter is that the pixels for each color are not contiguous.

Traditional cameras cannot product high quality images for both visible light and infrared light without mechanical changes, such as changing the focal-length of the lens or changing the filter(s) in the optical path.

### SUMMARY OF THE INVENTION

This invention comprises multiple embodiments of a camera consisting of multiple lenses and multiple image sensors (a “MLMS” camera) manufactured and configured in such as way as to gain significant and novel advantages over a camera with a single lens and single sensor.

Each lens is coupled with a corresponding sensor; we refer to each lens and sensor combination as a lens/sensor pair, or as a sub-camera. The camera of this invention has multiple lens/sensor pairs, often arranged in a line or an array.

One of the most important benefits is cost. If we assign a nominal cost of one to a lens matched to an APS-C (23.6×15.7 mm) sensor size, we might then have a cost of twenty for a full frame lens (36×24 mm sensor size). Yet, the area difference of the two sensors is only 2.34. If we build and use three lenses, each with a corresponding APC-C size sensor, we might then have a production cost savings for the lenses of 20/3, or more than a factor of six, for the same effective total sensor area.

In the simplest embodiment the images from the multiple sensors in the camera are summed or averaged electronically to produce a single final merged image.

However, in other embodiments we provide many additional interesting and novel capabilities.

We often refer to the image or the image data from one lens/sensor pair as a “sub-image.” The image presented or stored as a result of combining data from multiple sub-images we often identify as a “final image.”

In one embodiment we use the good pixels (valid image data) from some sensors to replace the bad (defective or inferior quality) pixels in other sensors. This embodiment permits the use of lower-cost silicon, which would normally have to be discarded due to excessive pixel defects.

In one embodiment we select different colors for different lens/sensor pairs, eliminating or simplifying the currently required precision color filters required for single-sensor electronic image sensors. There is a second benefit of having contiguous pixel data for all colors, and thus higher effective resolution for otherwise identical lens and sensors, in this embodiment. Because there is a single color used for each lens/sensor pair (in at least a portion of all pairs in the camera) the color filter is simplified, including placement options. In one embodiment the color filter is built into the lens, for example, by means of coatings.

The above embodiment has a unique and novel feature: by using only one color for each lens/sensor pair, chromatic aberration does not need to be corrected in any of these lenses. As chromatic aberration is one of the most major and one of the hardest aberrations to correct, this embodiment results in dramatic cost savings with no loss in final image quality. In this embodiment, an appropriate narrow band optical filter is used, along with a different color pass-band, for each lens/sensor pair.

Traditionally, these three colors are used to create color images: red, green and blue. Often, for electronic sensors, the green pixels make up half of the total pixels, with the red and the blue pixels one quarter of the total pixels each. This arrangement provides a convenient way to arrange or pack the different colored pixels (generally a function of the overlaid filter) in a rectangular pixel array. However, this 2:1:1 arrangement may not be optimum with respect to final image quality. In our invention, we provide a more flexible ratio of different color sources, include the ability to include more than three colors in the final image. Using more than three colors as the source for a full color image provides for both more intense (wider gamut) and more accurate color rendition. Also, it permits the use of light beyond the visible, such as IR and UV.

In one form of the above embodiment one lens/sensor pair responds to green light exclusively while a second lens/sensor pair has a traditional “per pixel” color filter, however this filter uses a checkerboard pattern of blue and red filters. The final merged image is created from data from these two lens/sensor pairs. This arrangement provides twice the resolution of traditional electronic sensor camera designs for otherwise similar lenses and sensors. Also, with twice as many pixels for each color the shutter speed may be cut in half, reducing motion blur or camera shake in the final image, with no other loss of image quality.

In another embodiment we design both the lenses and sensors to respond to non-visible wavelengths of light, in particular, infrared (IR) light. Typically, neither lenses nor the filters in a traditional camera can effectively produce high quality images in both visible and IR light due both the focal-length differences in the lenses and the need for different filters in the optical path. In this embodiment we can produce a single combined or final image, taken at the same time, in the broader spectrum inclusive of both visible and IR light. In another embodiment, we include ultraviolet light (UV) sensitivity in at least one lens/sensor combination.

In one embodiment at least one lens/sensor pair is responsive to CIE IR-A (a particular designation of specific IR wavelengths). In another embodiment at least one lens/sensor pair is responsive to CIE IR-B. Common silicon sensors typically include usable sensitivity up to about 1100 nm. However, sensors can be made that include sensitivity up to 1800 nm, for example, by the use of InGaAs. Wavelengths up to 5000 nm can be constructed from indium antimonide (InSb), Mercury cadmium telluride (HgCdTe) and by lead selenide (PbSe) semiconductor material. These different sensor materials are used, in one embodiment of the invention, in different lens/sensor pairs so that the camera is enabled to take photographs using an extremely broad light spectrum.

There are numerous advantages to imaging in the IR, including the ability to cut through haze, which thus produces clearer, more beautiful landscape images, even with an inexpensive consumer camera. IR-B is used to image some thermal sources.

In some embodiments, one or more sensors are cooled.

In another embodiment the camera comprises multiple lenses of different focal-lengths such as wide-angle, normal and telephoto. Using this embodiment, the user can take a single picture, and then decide later on her desired field of view, her desired focal-length, and her desired cropping, without a loss of resolution.

In a variation on the above embodiment, the images from the different focal-lengths lenses are combined into a single final image. However, the pixel resolution near the area of interest, typically near the center of the final image, is higher than near the periphery of the final image. This is implemented by using the effective resolution of the telephoto for the center of the final image, the effective resolution of the normal lens for the middle “donut” area of the final image, and the lower effective pixel resolution of the wide-angle lens for the periphery of the final image. This variable resolution is consistent with typical desire of the camera user and the person appreciating the final image. This variable resolution weighted towards the center of the final image is an improvement over prior art, which uses a constant resolution over the entire image. Consider, for example, a photograph of a wedding party. Near the center of the subject matter are the bride and groom. Surrounding them are various relatives. Near the edges of the picture are ground, sky and church. The combined image of this embodiment provides not only the (wide angle) context for the entire wedding party, but also the ability to zoom in, magnify, or visually focus on the high acuity of the faces of the married couple in the center. Such an image could be printed very large while still appearing sharp in the most important area of interest.

In yet another embodiment, the multiple lens/sensor pairs point at different subjects. That is, their optical axes are not parallel. They are arranged to point somewhat to the left, center and right of the primary subject. The sub-images from the multiple lens/sensors are stitched together into a contiguous panorama to form the final image. Although such stitching of multiple images is prior art, the prior art requires multiple images taken at separate times, and thus a truly contiguous result is impossible due to changes in the subject between the times each of the multiple images were taken. For example, taking such stitched panoramas of sporting events is essentially impossible today with low-cost equipment. Even landscapes do not properly stitch with the prior art due to shifts in plant position caused by breeze. This invention solves this problem to create truly contiguous panoramas.

Note that this “panorama” embodiment is designed to capture either a flat field on both axis, or a field curved on one-axis and flat on a second axis. The ability to have flat field on one axis and a curved field on the second axis is a unique feature of this invention. Note that this “panorama” embodiment camera also takes non-panorama photographs where both axis are a flat field.

In one embodiment incorporating a final panorama image comprised of merged sub-images, perspective correction is used. To explain this perspective correction, consider first how perspective is rendered in a single, traditional image, particularly wide-angle images. In these traditional images perspective causes objects near the corners of the image to “lean in” towards the center of the image. For example, consider a landscape with the horizon near the center of the image and ground below the horizon. On this ground are a series of parallel sticks, aligned towards infinity. In the lower corners of the traditional image, the sticks on the ground will appear to be angled in toward the center of the image rather than appearing parallel to the sides of the image. Now consider a second image for a panorama taken at an angle from the first image that includes some of the same sticks on the ground. Again, the sticks in the corner of the image will appear angled towards the center of the image. As the two traditional images are merged to create the panorama, a stick in the lower right of the left photograph will be at a crossed angle with identical stick appearing in the lower left of the right photograph. These crossed images of the same stick present a major challenge in traditional panorama creation from traditional images. In one embodiment of this invention this traditional perspective problem is improved by using a larger number of sub-elements. The resulting continuous panorama image appears as if created from a very large number of sub-images, where each sub-image comprises a thin vertical slice of the final panorama image. In an ideal case, each (virtual) sub-image is a single-pixel wide slice, and thus has no left-to-right perspective. To visualize this effect, consider a photographer standing in the center of a field, surrounded by sticks, all of which point towards the photographer. The final panorama, corrected for perspective as described herein, would be a photograph where each stick appears parallel and aligned with the sides of the final photograph. The multiple-lens camera of this invention provides a higher-quality so-corrected panorama than is possible from a smaller number of sub-images. One such quality improvement is less or no “waviness” of the bottom and top border of the panorama due to the correction from a smaller number of sub-images. That is, this invention produces a final panorama image that is rectangular in shape, rather than wavy, as produced by the prior art.

In yet another embodiment the different lenses are focused at different distances from the camera. For example, close-up, medium distance, and infinity. This allows the user to take a photograph very rapidly without the need to focus. Even with an auto-focus camera, focusing takes time, particularly if the camera needs to provide its own light source on the subject in order to focus. The camera may then automatically select the sub-image with the sharpest focus to use as the final image. Or, alternatively, the user may select the desired image at a later time. For example, in a crowded party, it may be impossible for any automatic system to know which of the many faces in the images are the ones the user desires to see in the sharpest focus.

In a variation on the above embodiment, the sharpest portions of all of the sub-images are combined to produce a single final image that is sharp from close-up to distant, even with moving subject matter. This is a capability not achievable by the prior art.

In yet another variation of the above embodiment, the camera is able to determine the distance of various pixels of the subject matter both by the focus of that area of the image and also by the parallax introduced by the multiple lens/sensors. In this way the camera of this invention intentionally blurs the background behind and around the desired subject. This background blur is substantially more blur than created by the use of a single lens properly focused on the subject, even for a camera with a large sensor, large lens, and high numerical aperture. This background blur is a highly desired feature often used in high-quality portraits. In the prior art, such blurred backgrounds required large aperture (low f-stop) lens, which are traditionally very expensive. This camera is able to produce high quality blurred backgrounds far more inexpensively and in a much smaller form factor, due to its unique ability to accurately identify the subject distance on a pixel-by-pixel basis.

In yet another embodiment the camera produces not just one stereo image, but a set of stereo images, where the stereo effect is not only variable depth based on the choice of which sub-images are combined for the left and right view, but also stereo “top to bottom,” rather than “left-to-right.” This feature allows the user to turn the camera 90 degrees and still produce stereo images, which is a feature not available in prior art stereo cameras. In addition, this embodiment permits a viewer of the final stereo images to rotate his or her head sideways and still see a stereo image, such as might be used in a gaming or virtual reality applications, or simply watching (3D) television in bed. This capability does not exist in prior art stereo cameras.

Camera users frequently rotate the camera 90 degrees in order to achieve either a landscape orientation or a portrait orientation. In the prior art implementation of stereo imaging such rotation eliminates the stereo feature. In the implementation of stereo imaging in this invention, stereo imaging is preserved even when the camera is rotated 90 degrees, or in fact, rotated any angle.

In one embodiment, a sensor, such as an accelerometer, is used to determine camera angle. The output of this sensor is used in the computation of the stereo image(s) so as to create a natural stereo image for a person with a natural upright head position (that is: eyes horizontal).

A key improvement over prior art stereo cameras is the use of multiple-source points of view. In the prior art, two imaging systems are used to create two images, which correspond directly to an image for the left eye and an image for the right eye. Neither the prior art stereo camera nor associated post processing had any data, knowledge, understanding or structure of the depth aspects of the subject or subjects. Such object depth was determined entirely in the brain of the person viewing both images with both eyes. In our invention, the camera uses the comparison of multiple images to determine within the camera 3D structure. The camera also uses focus information as part of the input information to determine both depth and the edges of different subjects at different distances from the camera. This depth, or 3D, information is preserved so that different views of the subject are possible. The different views use the image data far removed in time and place from the time the photograph was taken. For example, a user of the final photograph may decide to blur the background, remove the background, or replace the background entirely. Alternatively, the user of the final photograph may decide to keep the background sharp, but blur the foreground subject matter. Such processing functions may also be performed inside the camera in some embodiments. These capabilities are not available in the prior art stereo camera.

A particularly unique and novel aspect of this invention is providing many of the features of the discussed embodiments simultaneously. Thus, the camera is not dedicated to a single feature, embodiment or function at the time the camera is purchased or a photograph is taken.

One feature of many of these embodiments is that they are relatively insensitive to blockage of a lens by a user's finger. Such a blockage is determined computationally and that lens/sensor sub-image or the blocked portion of that sub-image is not used to create a final image.

Consider, an exemplary array of 4×6 lens/sensor pairs. Of the 24 lens/sensor pairs, various ones are dedicated to various functions described herein. The user then selects, either just prior to taking the photograph, just after taking the photograph, or at a considerably later time, the desired effect. The user also generates, at the user's option, several different resulting final images, each with a considerably different purpose, all taken with a single push of a button at one instant in time, with a single image-capturing effort by the user. This unique feature of this invention may be thought of as, “taking all the pictures you might want in the future of this subject with a single push of a button.”

In one embodiment, all portions of the final image are in focus. An algorithm within the camera, or executing on a post-field processor, selects portions from each lens/sensor captured image those portions that are in sharpest focus, then merges those selected portions into a contiguous, natural-appearing final image. Such a merger also applies, in another but similar embodiment, to proper exposure. That is, the most optimal exposure areas from multiple lens/sensor captured images are identified and then those areas merged. We refer to the first embodiment in this paragraph is “all focused,” and the second embodiment as “all proper exposure.” In yet a third, similar embodiment, different ISO settings areas from multiple lens/sensor captured images are merged, again selecting optimal areas. For example, a still subject within the final image is optimized with a low ISO in order to achieve low noise for that subject, while a moving subject within the same final image is optimized with a high-ISO in order to stop the motion to minimize motion-blur of that subject. This third embodiment is referred to as “all lowest noise.”

Algorithms to identify sharp focus area within an image is well known to one trained in the art. Such methods including searching, adjusting, and selecting areas with the most high-spatial frequency information, or alternatively by using phase detection to identify optimal focus.

In one embodiment, one or more lens/sensor pairs implement phase-detection focus.

In another embodiment of this invention the sensors are not discreet pieces of silicon (or other material), but rather different areas on a single piece of silicon, further simplifying manufacturing. The areas of the single piece of silicon in between the imaging areas are used for computation and storage, in one embodiment, or alternatively are simple blank, unused silicon.

In another embodiment, the lenses are not manufactured as separate lenses, but rather manufactured as a group of lenses. For example, each plastic lens may be a part of a single molded piece that includes all (or a subset) of the lenses in the camera. The different effect lens elements may be connected by thin connections of the same plastic from which the lenses are formed. These connections may be sufficiently rigid to assist in the relative alignment of the lens elements during assembly; or, the connections may be intentionally flexible enough that the lenses may shift slightly to seat properly in a substrate, such as metal, that is manufactured specifically to achieve the desired relative alignment of the lens elements. Similarly, the lens alignment substrate, which corresponds roughly to the “body” of a traditional lens, is manufactured as a single piece. Thus, in one embodiment, the multiple lenses are manufactured as single component, the substrate is manufactured as a single component, and the sensors are manufactured as a single component. This manufacturing embodiment permits a very large number of sub-cameras to be manufactured inexpensively. This exact arrangement is not necessary in all embodiments and may apply to a subset of all the lens/sensor pairs assembled into one camera of this invention.

In one embodiment the camera uses exclusively or primarily IR light for the final image. This has significant advantages in several applications. One such application is covert photography, where the user does not want the subject or other people in the area of the camera or the subject to be aware of the activity of photographing. This application occurs in police and surveillance work. Another application is when it is inappropriate to disturb the subject with a visible flash, such as in medical applications, performance applications such as live theater, sports application such as gymnastics, traffic applications or when it is simply preferred to not to temporarily blind the subject with a flash.

Such an image is created entirely in the IR spectrum. Traditionally, such IR images are rendered in “black and white.” However, in a novel embodiment this camera uses existing or dim supplemental light in the visible spectrum to establish color from a first set of one or more lens/sensor pairs, although not acuity of the subject, and then uses IR light to establish the acuity of the subject from a second set of one or more different lens/sensor pairs. These sub-images are then merged to provide a full color final image that is both sharp and low-noise.

In yet another embodiment the different lens/sensor pairs are configured, typically dynamically, for differing ISO sensitivity and/or different exposure times. A high ISO sensitivity allows the sensor to record an image with less light on the subject, however the resulting image has more noise. A lower ISO produces a lower noise image, however requiring either more light or a longer exposure time.

By combining sub-images of differing ISO and differing exposure time of sub-images taken at the same moment of the same subject is accomplished using this invention. Such a capability is not possible in the prior art. For example, a first set of high ISO or a short exposure time lens/sensor pairs is used for a fast moving image, such as a sports subject. At the same time, a second set of lower ISO or longer exposure time lens/sensor pairs is used to capture a second sub-image set. The fast moving subject is extracted from the lens/sensor pairs in the first set. The remainder of the final image is extracted from the second set of sub-images. Thus we might see a football player at the exact moment he catches the ball, with excellent resolution of the facial expression, his fingers, and the ball. However, these portions of the image are grainy, or noisy, and they have poor color quality. At the same time, in the same image, we see the other players in the background with excellent color rendition and low noise; however, they are shown with motion blur due to a longer exposure. At the same time, in the same final image, we see the grass and the stadium rendered in with excellent resolution, sharpness, accurate color, and low noise.

In one embodiment the effective resolution of the resulting final image is increased by the use of multiple lens/sensor pairs. Consider an exemplary set of twelve sensors, each with 1000 by 1000 pixel resolution. In the prior art, such a sensor would produce a resulting image of 1,000,000 pixels. (We ignore for the moment tricks used to deal with color sub-setting and artificial resolution enhancement algorithms.) However, in our invention, we have 12,000,000 pixels to work with due to the twelve sensors. Consider, as a simple case, a feature on the subject that is exactly one pixel is in size. With a normal lens/sensor/image processing method, a 2D Gaussian blur and filter are assumed, and so the one pixel feature is spread out slightly to neighboring pixels, resulting in less contrast and a slight expansion of the size. Thus, a traditionally implemented lens/sensor/image processing blurs a one-pixel subject to larger than one pixel. However, in our camera that single-pixel subject is imaged slightly differently by each lens/sensor pair. In some sub-cameras the one pixel subject is split between two pixels, each recording about half of its contrast, or in some other ratio. In some sub-cameras the subject pixel is split between four adjacent pixels. An in some sub-cameras, the one pixel subject is almost perfectly aligned with a single pixel sensor, which then records the highest contrast compared with the neighboring pixels and compared with the other lens/sensor images. By comparing at the pixel-by-pixel level the differences between the various lens/sensor images, noting that the alignment of the various lens/sensor pairs varies by at least a sub-pixel amount, the algorithm in the camera determines accurate the size, contrast and color of the one-pixel subject. This resolution and accuracy is not available in the prior art, using the same sensor size and lens quality.

The technique to do this adjacent pixel processing is similar to the known technique in the art of “dithering” a signal. The known dithering technique is generally applied to linear, one-dimensional data, rather than two-dimensional data as performed in this invention, and is traditionally done by adding noise or shifting a sampling window, not by analyzing multiple images taken simultaneously as in this invention. In our invention we do not need to add any noise or motion to accomplish at least the same level of resolution enhancement.

Thus, in this embodiment, we may produce a final image that is, using the above example, 4,000,000 pixels, and that final image contains more image data than any one lens/sensor is able to record. One algorithm to accomplish this is essentially the reverse of anti-aliasing, i.e., the algorithm used to produce the appearance of “sharp” characters on the screen, with more apparent resolution than the screen resolution, by displaying the edges of each character stroke in a gray-scale value that is equivalent to the percent of the pixel that would be covered by the character stroke of much higher resolution.

A variation of this embodiment is used to eliminate the moiré effect produced when a repetitive pattern is imaged by an array that has a basic resolution of less than twice the subject frequency. The prior-art solution to eliminate moiré is to blur the image sufficiently. In our invention the images from the multiple lens/sensor pairs are combined to eliminate the moiré without the necessary blurring. This accomplishes higher final usable resolution of the final image for the same underlying sensor and lens resolution of a single lens/sensor camera.

In another embodiment, the aspect ratio and shape of the sensors is not rectangular. In a traditional one-lens, one-sensor camera, the sensor is rectangular because people are used to and prefer a final image that is rectangular. In a sense this is wasteful of the lens because the lens creates a round image of the subject at the image plane. Using a square sensor wastes the image produced by the lens in the area between the square image sensor and the circle in which it is inscribed. A rectangular sensor shape wastes even more of the potential image.

In our camera, since we are combining multiple sub-images into a final image, we have no particular need to use rectangular sensor. Indeed, by using circular sensors we are able to take more advantage of the lenses. We are thus “wasting less light,” or “wasting less lens” that has to be paid for in production, compared to prior art.

Traditionally, lenses and their bodies have been circular.

In our invention, in a preferred embodiment, the lenses are as close together as possible to avoid wasted space in the final camera. Close lens spacing reduces the total size and thus cost of any components of the multiple lens/sensors such as a sheet of lenses, a single lens substrate, or multiple sensors on one piece of silicon. For a circular lens of the prior art, all of the glass or plastic contributes light to the image plane. Making the lens a different shape, say square, by cutting off the sides of one or more elements of the lens reduces the total amount of light the lens provides to the image plane. However, in our invention, the slight loss of light is more than offset by the use multiple lenses. A slight trimming of the individual lenses to a rectangular or hexagonal shape permits tighter packing with the above said advantages.

Consumers often prefer portable devices with a convenient rectangular shape, yet lenses are generally round, so prior-art cameras have a larger front area than optically necessary. Even using round lenses in an embodiment, our MLMS camera invention captures a greater quantity of light for a given size camera than a prior-art camera by the use of a hexagonally closely-packed array of lens/sensor pairs. Thus, this invention achieves a higher ratio of light gathering to camera front area than the prior art.

In embodiments using IR light, which is used for focus and/or final image generation, it is advantageous to have LED IR illuminators either as part of the camera or as an optional accessory to the camera. The accessory is mechanically or electrically attached to the camera, or it has wireless connectivity with its own power supply.

Silicon sensors are particularly sensitive in the IR range and LED IR illuminators are both bright and efficient. Thus, use of IR light for general photography in our invention has many advantages. A key mode and embodiment of this invention is to use the IR light to produce acuity in the final image. That is: for the subject edges and basic gray-scale brightness (“luminance”) of the subject. Then, white light, either natural or artificially supplied, is used to identify the proper visual colors (“hue” and “saturation”) of each part of the image. In some cases, the “color” needs to override or adjust the gray-scale value in order to provide realistic natural rendering of all colors and shades in the final image. Thus, in a key embodiment the final image luminance comes from IR light sub-cameras while hue and saturation in the final image come from visible light sub-cameras.

Many prior art cameras have face recognition built in. Face recognition has a particular advantage in this invention as the characteristics of human skin coloring (luminance, hue, saturation and texture) under both visible light (luminance, hue, saturation and texture) and IR light (luminance and texture) are well known. This invention images a high acuity face as part of a larger subject using IR light at the same time capturing a lower acuity visual light image; then performs face recognition using the IR sub-image; thus identifying the face areas in the sub-image; then applies the lower acuity hue and saturation to the face in the final image. Thus, recognized faces are well color corrected from the white-light sub-images while the facial details are generated from the IR light sub-image.

It is advantageous to have wireless remote IR illuminator units. In one embodiment one or several of these units are placed appropriately in a venue, such a church, party location, sports arenas, home, and an outdoor setting. When the user of the camera of this invention wishes to take a photograph the camera wirelessly turns on the installed IR illuminator units. These illuminator units provide highly professional lighting direction and “softness.” Also, they respond to many different cameras if one were to use or establish an open standard such as an IR pulse sequence or a known, licensed wireless protocol. Preferred protocols include Bluetooth and 802.11. An IR pulse sequence is easily implemented as a variation on published IR TV remote protocol. Although an IR flash could be used, the preferred embodiment is simply bright IR LEDs, turned on for the minimum time necessary to take the photograph, considering the delays involved in the wireless protocol and the delays within the camera and IR remote illuminators. These IR LEDs, in some embodiments, are not able to operate continuously at their full brightness, due to power, heat and other limitations. However, even with multiple cameras taking multiple photographs, the total duty cycle for the IR LEDs is typically low, for example, below 1%. The IR illuminators for a temporary event are typically placed at the venue near the start of a venue event and removed near the end of the event. For some venues, the venue provides permanent IR illuminators, well placed, as a courtesy to visiting photographers. This feature has the unique ability to allow one type of visual lighting for people and a completely different layout of light for photography in the same venue. This feature is a unique benefit of this invention not available in the prior art. A second benefit is that some physical objects, such as tapestries and paintings, are degraded by visual light, and thus lighting in many museums and churches is intentionally dim to preserve these objects. This described IR lighting system has the unique benefit of preserving these objects and also permitting high quality photographs to be easily taken.

For many sports, such as gymnastics, and for many performance events, such as opera, flash photography is not permitted as it can put the athletes at risk and disturb both the performers and the audience. The use of IR light as described herein for this invention, solves this problem.

In one embodiment this the luminance as determined by the IR light and the hue and saturation as determined by the visible light is not performed on a pixel by pixel basis. The visible light sub-image may have a longer exposure time or may have more noise, including color noise, than the IR light sub-image. For example, the visible light sub-image may have motion blur while the IR light sub-image does not.

Thus, the algorithm in this embodiment for combining the IR and visible light images uses the visible light image to determine the proper color (saturation and hue) of an general area, then use the IR image to determine the exact area in which to apply that color. For larger areas, such as skin or sky, a large amount of averaging and the use of smooth gradients is be used to produce smooth, low-noise color. For highly detailed subjects such as blooming plants and flowers, or the iris of an eye, the applicable areas in which to apply color are quite small, which generate more (small) errors and require less averaging and therefore generate more noise in the final image. The level of detail in the IR sub-image is used to determine the amount of averaging and the size of the source area from the visible light sub-image to apply to that area of the final image. The level of blurring (if any) in the visible light sub-image is used to determine the extent to which boundaries in the IR sub-image override any apparent (but blurred) boundaries in the visible light sub-image.

Another advantage of this invention, besides cost, is lower weight and lower size in the camera, and thus increased convenience for the camera user. In particular, the combined lenses and sensors are implemented in a camera that is thin compared to prior art cameras, and thus the camera shape is more compatible with popular mobile devices, including mobile phones and tablets.

One key element in many embodiments is the calibration of the multiple lens/sensor elements. A second key element in many embodiments is the software to combine the multiple sub-image data into a final image or images. Such software may execute within the camera or on an external processor. Such software may be executed approximately the same time as the images are captured or may be performed at a later time. The software may operate on data as it is read out of the sub-image sensors, on stored image data within the camera, on stored image data on a device external to the camera, or on image data that has been transmitted.

In some embodiments the camera, automatically, executes algorithms to generate a final image. In other embodiments, the camera stores multiple sub-images, permitting a user to select or create a final image or images at a later time. While the steps described herein proceed automatically in some embodiments, a user may wish to provide certain sub-image merging steps manually. As one example, a user may wish to improve on the camera's automatic selection of foreground/background pixels for the purpose of background blur. A user may also select desired parts of the photo to be best focused or best lighted by simply touching those parts or outlining those parts. A user may also adjust lighting or focus manually. This invention permits the user to make these adjustments either before, during or after the images are captures. Such a capability exists only in very limited forms in the prior art.

While the descriptions in this specification describe the capture and processing of still images, the invention also captures and processes video. In one set of embodiments using video, the video is shot at a given frame rate, and the frames are synchronized with each other in each frame cycle, and the camera then performs processing either: (1) combines the sub-images from each frame cycle into a final image for that cycle, in real time, then feeds that final image into a normal video compression (e.g., H.264) and storage pipeline; or (2) the sub-images from each frame cycle are compressed individually using a lossless still-image compression algorithm such as PNG or TIFF, and then stored for later processing; or (3) the sub-images from each cycle are saved as separate streams, one per sub-camera, each stream employing a lossless video compression process such as YULS or MSU; or (4) each sub-image stream is compressed using a codec that is lossy, but which preserves some features needed for later combining the sub-image streams into a final-image stream. These four video processing options are four separate embodiments.

In some embodiments of this invention some or all of the image processing is performed by a post-field processor. By this we mean that instead of using a processor and algorithms within the camera, a processor with algorithms separate from the camera is used to create one or more final images. One motivation for this embodiment is that “memory is cheap; computation is expensive.” In these embodiments multiple intermediate images and/or data from multiple lens/sensor pairs are stored and transferred to the post-field process for processing at a later time than the original exposure taken by the user of the camera in the field. The post-field processing may be automatic, or performed by the user, or by another person. In various embodiments it is performed on a user-device such as a laptop computer, a PC, or other personal electronics, or performed in the internet cloud as a service. The intermediate images in the camera are stored on a raw data format, or compressed with a lossless compression algorithm, or compressed with a lossy-compression algorithm that preserves the necessary information to accomplish the post-field processing tasks. Post-field processing has numerous benefits. For example, the user may have a much-higher resolution display available, with less interfering ambient light, on which to view, analyze and select images, areas, formats or features. Also, the user has more available time for such image-processing tasks, rather than distracting from the enjoyment or time-pressure of the field-capture of images. Specialization of tasks is available, such as having a field-expert, such as a sports photographer, work in the field while an image editor, such as a magazine editor, performs image optimization and feature selection that suits her preferences or needs post-field.

In one embodiment, foreground, background and depth information about the subject matter in photograph is provided by the camera. The use of multiple lens/sensor pairs provides a potent and unique ability to generate accurate depth information about the multiple subjects in a photograph. In one embodiment, a z-axis, or depth, or “distance-from-the-camera” array is provided in association with the photograph. In one embodiment, this z-axis image (the array of depth information), is the same aspect ratio and resolution of the associated photograph. It is a monochrome image, where for each pixel white represents close to the camera and black represents distant. The mapping between distance and gray-scale value goes from zero (touching the lens) being pure white to infinity being pure black, or a reduced range is used. An exemplary formula is GV=c1*arctan(c2/d), where GV represents the traditional linear gray-scale value, d is distance, and c1 and c2 are constant conversion factors to map the units of d to the range of GV. For example, if c1=2*pi, c2=10, d is feet, c2/d is in units of radians, then GV has the traditional range from 0 to 1 with mid-gray being 0.5 at c2=10 feet from the camera. A reduced range is from the closest focus of the camera (white) to the farthest distance the camera's flash will reach (black). Other formulas for GV are used in other embodiments.

In another embodiment the gray-scale z-axis array is further enhanced by using color to encode the slope of the subject at the corresponding pixel. In one embodiment the color from a traditional color wheel represents the angle of the slope of the subject with the 360 degrees of the color wheel corresponding to the 360 degrees in the possible angle of the subject's slope. The subject's slope is measured relative to a (reference) plane at the subject normal to a (reference) line from the optical center of a lens on the camera through the subject. In one embodiment, the saturation of the color represents the angle, or steepness of the slope. A sloped subject that is parallel to the reference plane has zero saturation, or gray. A slope that is tilted 90 degrees so that the surface of the subject is parallel to the reference line is represented by a fully saturated color pixel. A saturation range less than 0 degrees through 90 degrees is possible. For example, a useful range is from 0 degrees to 60 degrees. Subjects with a tilt greater that 60 degrees, in this example, are also shown with full saturation. The subject tilt is determined, in general, by observing that different portions of the subject are different distances (the gray-scale value) from the camera. This representation may be identified as a vector-field.

The particular embodiment discussed in the previous paragraph has the unique attribute that the limitations of color representation, being three fully independent attributes (hue, saturation and value; or hue, chroma and lightness; depending on the preferred color model), are well matched to limitations of representing the distance and slope of subjects. In particular, the dual-cone color model (white at one peak, black at the second peak, with the color wheel at the base of the two cones), also known as the color sphere of Johannes Itten, matches the fact that the angle of the slope is not particularly relevant at the point where the subject is against the camera lens (white) or at infinity (black). Slope detail is most available at middle distances, which correspond to the widest portion of the dual-code color model. Variations of the dual-cone color model include representations by Kirshman, Munsell, Pope and YCbCr spaces.

Note that it is not necessary that the pixel resolution of the z-axis array match the pixel resolution of the associated photograph, as scaling is used in some embodiments to relate the pixels of the z-axis array to the pixels of the final image.

In one embodiment, the camera determines the distances of portions of the subject, and from that the slope of portions of the subject, by the use of two pair of sub-cameras, one pair arranged vertically and one pair arranged horizontally. The parallax between two image portions from two sub-camera pairs are compared. Deviations between the two image portions indicates a distinct boundary between a foreground object and a background object. The deviations from both sub-cameras pairs are combined, for example by summing or taking a maximum, in order to identify a complete boundary around a foreground object. This capability does not exist in stereo camera prior art. The width (say, in pixels) of the deviation determines the distance between the foreground object and the background. The direction of shift of the object between the two images determines which side of the deviation is foreground and which side is background. Typically, 2D correlation on the entire image, areas within the image, and sub-areas within the area, is used to determine the reference alignment (at infinity) and the amount of deviation at each point in the photograph. Determining the boundaries of objects is enhanced by the use of line-following algorithms, color matching, texture matching, and noise matching, as is known in the art. In addition, the comparison of brightness between a flash image and a natural-light image (taken sequentially but at almost the same instant in time) is used in some embodiments to assist in determining distance, angle, and slope of objects in the subject area. Some objects, such as faces, are determined by matching characteristics (including, shape, color, texture, and nearby objects) to a library of known objects. In addition, in some embodiments, motion of an object or sub-area between two frames taken at different times is used to enhance subject (the moving portion against a still background) isolation.

### BRIEF DESCRIPTION OF THE DRAWINGS

FIG. 1 shows the single lens and rectangular sensor of prior art.

FIG. 2 shows an exemplary array of sub-images and a rectangular final image area.

FIG. 3 shows identification of sub-image area in an exemplary embodiment.

FIG. 4 shows sub-images composited to create a panoramic final image with variable resolution.

FIG. 5 shows a sheet of multiple lenses manufactured as a single piece.

FIG. 6 shows an exemplary multiple lens substrate.

FIG. 7 shows a side view of a multiple lenses.

FIG. 8a shows a line of multiple lenses bent to provide differing subjects for a set of lens/sensor pairs.

FIG. 8b shows a different embodiment of a connector between multiple lenses.

FIGS. 9a through 9d shows a set of calibration targets.

FIG. 10 shows overlaid sub-image areas for the same subject, with two different final image aspect ratios.

FIG. 11 shows overlaid sub-image areas for three different focal-length lens/sensor pairs.

FIG. 12 shows a multiplicity of aspect ratios for a single round image area.

FIG. 13 shows identification of subject and background areas from two different sub-images merged into a final image.

FIG. 14 shows two different filters used for two different lens/sensor pairs.

FIG. 15 shows one embodiment of a completed camera, with 15 lens/sensor pairs.

FIG. 16 shows one embodiment of a software algorithm for this invention.

FIG. 17 shows a block diagram of the components of the camera in one embodiment.

FIGS. 18a, 18b, and 18c show steps in the identification and isolation of foreground and background objects.

FIG. 19 shows one embodiment using four lens/sensor pairs for use in isolating foreground and background objects.

### DETAILED DESCRIPTION

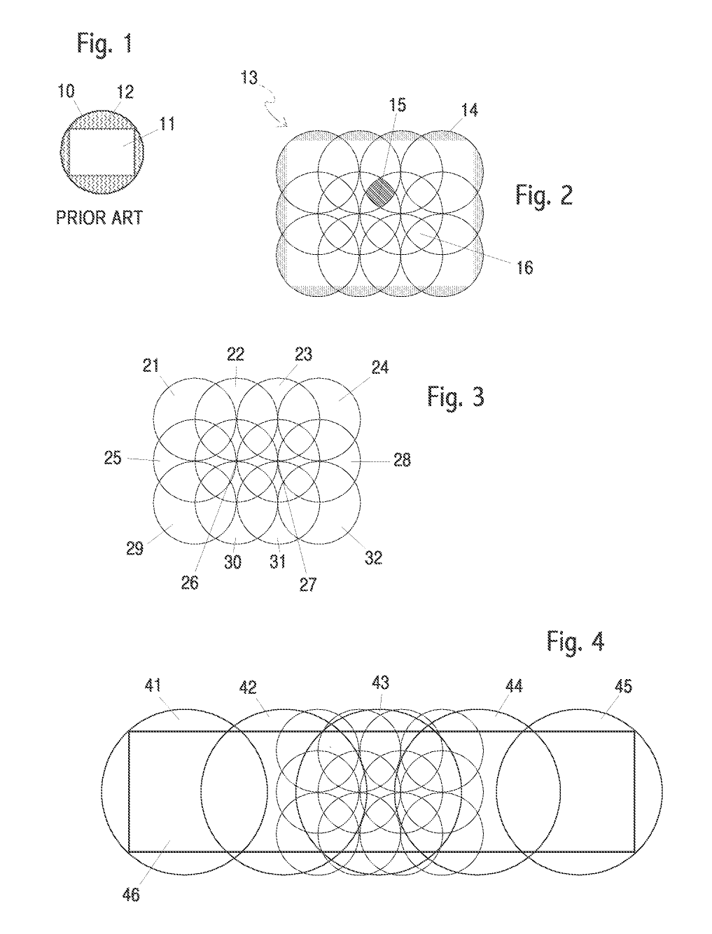

FIG. 1 shows prior art with a round image area in the image plane 10 and a portion of that area used by a rectangular sensor 11. The filled area 12 shows the “wasted” portion of the image area created by the lens but not used by the sensor and not available to the user of the camera.

FIG. 2 shows one embodiment with a four by three array of lenses creating an approximately rectangular image area 13 in the effective computed image plane of the camera. An exactly rectangular region is shown inside the shaded area 14. Note that this area shown in this Figure is a virtual image plane, as the actual sensors for the twelve lenses are not overlapping as the circles in this Figure. The twelve circles in this Figure represent the imaging areas in a final photograph where each circle is the available portion of the final photograph from one lens/sensor pair. This Figure shows how the twelve images would be overlapped to create the effective final rectangular image inside the shaded area 14, shown as a large white rectangle in the figure. Each sub-image area is shown as a circle. Note that the “wasted image area” 14 is a much smaller fraction of the total image area in this invention than the area 12 in the prior art in FIG. 1. For many embodiments, the lens or lenses are more expensive than the silicon used for sensors. Thus, maximizing the light from the (expensive) lenses, that is, wasting less light area 14, is a unique and novel feature of this invention. Area 16 comprises an overlap area of four lens/sensor pairs.

Shaded area 15 is comprised of pixels or image data from four lens/sensor pairs. Referring to FIG. 3 for numbering of the lens/sensor pairs in this figure, lens/sensor pairs 22, 23, 26 and 27 all contribute to area 15. Thus, this portion of the final image is able to benefit from the imaging input from these four lens/sensor pairs.

FIG. 3 shows one embodiment with a 4×3 array of lens/sensor pairs. Each circle in this figure represents the effective sub-image area contributed to the final image by one lens/sensor pair. For convenience in discussion, the lens/sensor pairs are numbered left to right, top down, from 21 through 32 in this figure. Note that there are many other arrangements of lens/sensor embodiments of this invention, from two lens/sensor pairs up to many hundreds (without specifying any limitation).

FIG. 3 shows a rectangular packing geometry. Each circle represents the perimeter of the usable image area from one lens/sensor pair. Other packing geometries provide higher density and/or lower manufacturing cost for certain embodiments. In particular, hexagonal packing of lens/sensor pairs is particularly efficient when the lens/sensor pairs are the same physical size.

For embodiments employing more than one size of lens/sensor pairs, sub-packing is particularly efficient. For example, larger lens/sensor pairs are arranged in a rectangular packing geometry, with one or more of the these larger rectangles sub-divided into four smaller, such as one-quarter the size, rectangles, wherein each smaller rectangle comprises one smaller lens/sensor pair. This sub-packing geometry is particularly advantageous in embodiments where a lens/sensor pair need only be a lower-resolution in order to accomplish the purpose of that lens/sensor pair. For example, computational functions such as face finding, edge finding, phase-detection focus or range finding require fewer pixels than a full, final image. Other features of the camera, such as high-speed video, deep-IR imaging, and imaging for a viewfinder benefit from a smaller lens/sensor pair.

In a hexagonal packing arrangement, a particularly efficient sub-packing places seven smaller, hexagonal lens/sensor pairs within one larger hexagon.

In some embodiments one sensor location is replaced with non-imaging purpose of the silicon, such as computation or storage. Placing storage elements in the array in place of one or more sensors has the advantage that the quantity of memory elements are adjusted so as to fill the available space. This implementation has the advantage of no wasted silicon. In another embodiment, the number of parallel processors is adjusted to fill or nearly fill the available space. This embodiment also optimizes the use of the total silicon area. Such memory, processors, I/O, or other necessary elements of the silicon in the camera also fill the area between the rectangular boundary of the silicon and the sensors, typically near the edge of the rectangular silicon.

FIG. 4 shows an embodiment where different lens/sensor pairs provide effectively different size areas of the final image. Typically, this is due to some lens/sensor pairs, such as 41, 42, 43, 44 and 45 being wider-angle than the twelve previously discussed lens/sensor pairs 21 through 32 shown in this Figure, but not numbered only in FIG. 3 for clarity. Alternatively, the areas of lens/sensor pairs 41 through 45 are due to large physical sensors. In this Figure, 41 through 45 are used to offer the camera user the option of creating a wide panorama final image shown as a wide rectangle 46. Note that the central area of the panorama, slightly larger than the area shown as 43, is also being imaged by the twelve “central” lens/senor pairs, and this central area is higher resolution or has other benefits compared to other parts of the panorama.

In an alternative mode or embodiment, lens/sensor 43 provides additional features to a final image corresponding to an area 16 shown in FIG. 2 based on sub-image data from the twelve central lens/sensors 21 through 32. For example, 43 provides IR data while 21 through 32 provide white light data. Or, 42, 43 and 44 provide color information, possibly with larger sensors including traditional RGB filters over the sensors, while 21 through 32 provide high-acuity, high resolution, fast shutter speed IR image data.

In another embodiment, this time focusing on the twelve lens/sensor pairs 21 through 32 shown in FIG. 3, the two most central pairs 26 and 27 use telephoto lenses with larger sensors, while 21, 22, 23, 24, 25, 28, 29, 30, 31, and 32 use very low cost medium focal-length lenses with small sensors. Should the user wish to have a telephoto final image, the area covered by 26 and 27 provides a wide aspect ratio, “full resolution” (relative to the lens/sensor pairs 26 and 27) image. The portion of image data from the remaining 10 lens/sensor pairs that overlap this final image is used to fill in for bad pixels in 26 and 27, for example. Note the very central most area where 26 and 27 overlap is covered by these two lens/sensor pairs providing a range of benefits as discussed for the image data in this overlap area. One such benefit is lower noise, due to the averaging of image data from 26 and 27.

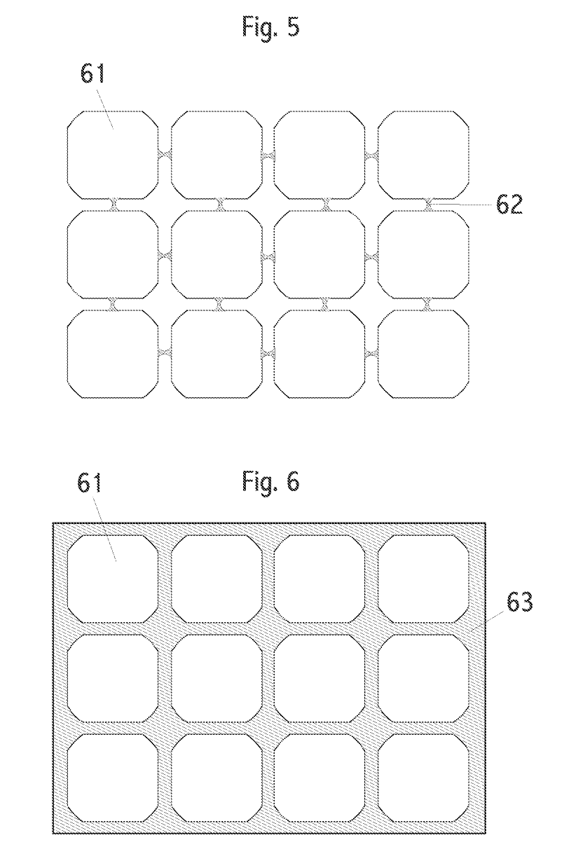

In FIG. 5 we see one embodiment of a 4×3 array of lenses, 61. The array is manufactured as a single piece, with connecting plastic 62 flexibly holding the twelve lenses together. Connection plastic 62 is also be “S” shaped, curved, wavy, saw-tooth, or spiral shaped to aid in providing lens-to-lens mobility, or “float,” so that lens alignment is achieved by the lens substrate, rather that in the lens molding process. In this embodiment we see a “truncated” round lens shape, as if the circular lens has been partially cut on four sides. In another embodiment, using hexagonal packing, the lenses would be cut, or truncated as if cut, on six sides, in a hexagonal shape. Other packing arrangements and other truncations are alternatives. In this Figure one can see one advantage of such truncation, which is to place the lenses closer together. Note that compound lenses are be used in one embodiment. For example, additional lens “sheets” similar to 61 would be manufactured, then the sheets stacked so that the lens elements of each lens, either touching or not touching adjacent elements, to create the final compound lens array. Such truncations provide both density and alignment advantages. Note also that in some embodiments lenses are coated or have other novel or traditional lens treatments.

Note that when we refer to “density” related to lens/sensor packing configurations, we mean both the density of image capture capability per unit of manufacturing cost, per unit of camera volume, per unit of camera surface area, and also light-capturing ability per unit area of silicon and per unit of user-perceived camera size, such as the frontal area, weight or convenience.

Note that no separation at all between the lenses of the array is required. The lens sheet is manufactured with sufficient tolerance that each lens is continuous with the adjacent lenses.

In FIG. 6 we see one embodiment of a precisions lens substrate 63. This is the mechanical frame into which the lenses are placed to assure the necessary final optical tolerance in the manufactured camera. Into the twelve openings in the substrate are placed the lenses of the sheet, 61. The lenses are ideally kept attached with the connectors 62, but are separated during assembly.

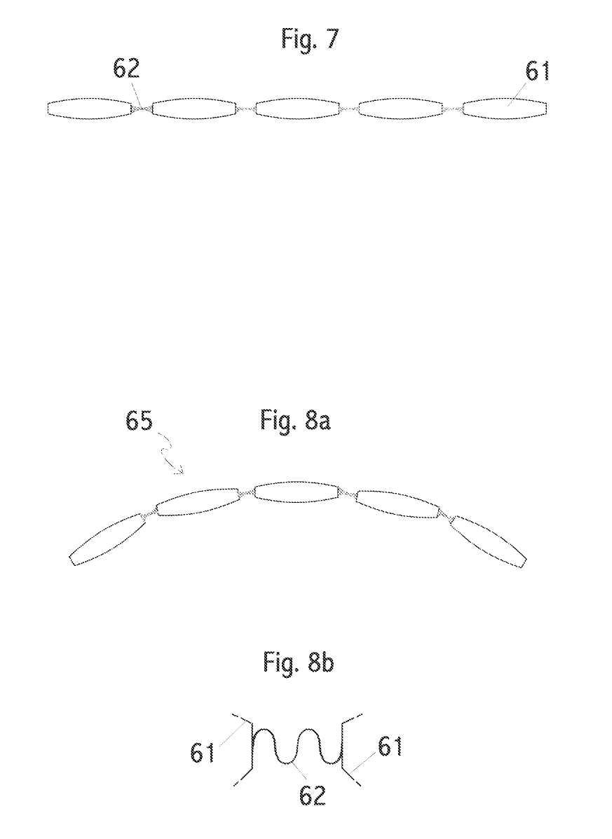

In FIG. 7 we see one example side view of a lens sheet or a group of lenses in an array of this camera. We see five lenses 61, although in other embodiments the sheet contains more. For example, the Figure could be side view of a 5×n array; or the sheet may contain fewer lenses. The connectors 62 are shown in one embodiment as previously discussed.

In FIG. 8a we see how the lens sheet is bent 65 prior to assembly in one embodiment so that the different lens/sensor combinations point along different optical axes to different parts of a photography subject. The individual lenses maintain their optical shape, while the connectors 62 between the lenses provide the flexibility to effect the curve. Typically, a precision substrate similar to 63, but curved, would provide the necessary physical positioning of the lenses in the curved sheet 65 to meet the optical requirements of the complete camera.

In FIG. 8b we see an alternative embodiment of the connector 62 between two lenses, shown partially each as 61. In this embodiment, the connector 62 is curved, sinusoidal, saw-tooth, coiled, or spiral in shape in order to provide additional mechanical compliance between the lenses 61.

The ideal, comprehensive calibration of the camera, as part of the manufacturing process or as part of a post-manufacturing method that is performed by a dealer, service person or the user, includes the following for each and all lens/sensor pairs, which ideally should be performed in this order:
a) Identification of missing pixels
b) Identification of matching “middle of image” locations for merging or overlap
c) Identification of rotation
d) Identification of effective zoom or focal-length
e) Identification of remaining distortions and aberrations
f) Identification of vignetting
g) Gain and offset measurements for a correction map
h) Color measurements for a correction map

Optionally, the following detection and/or calibration steps are performed. This information is not required dynamically in all embodiments due to the consistency of the manufacturing processes:
i) Lens focal-length
j) Color sensitivity
k) Rotation
l) Distortion and aberrations
m) Vignetting

There are significant advantages to performing some of these calibrations, particularly for (b) above, dynamically in the field. Such field calibration is performed periodically or as each exposure is taken. The purpose of periodic field calibration is to correct for camera and lens distortions, changes or damage over time, and for changes due to temperature or humidity. The purpose of dynamic field calibration for each image capture is to correct for bending and similar distortions caused by the user holding and flexing the camera during exposure, or other camera frame deformation that changes with each exposure. Typically, both the manufacturer (for cost) and the user (for convenience) desire the camera to be as light as possible. However, a light camera is generally more subject to mechanical deformation than a heavier camera (for comparable materials). Alignment of images lens-to-lens should ideally be done to sub-pixel accuracy. Even a tiny amount of camera bend will change the lens-to-lens optical centerlines by more than one pixel. Thus, dynamic calibration for at least this relationship is a preferred mode for some embodiments. Note specifically that such calibration is be performed post-field, as discussed elsewhere herein, in some embodiments. Bending of the camera frame will also introduce optical distortion; thus calibration to minimize this type of distortion is also performed dynamically in one embodiment. Note that some types of distortion and aberration such as chromatic and coma, can be corrected in software.

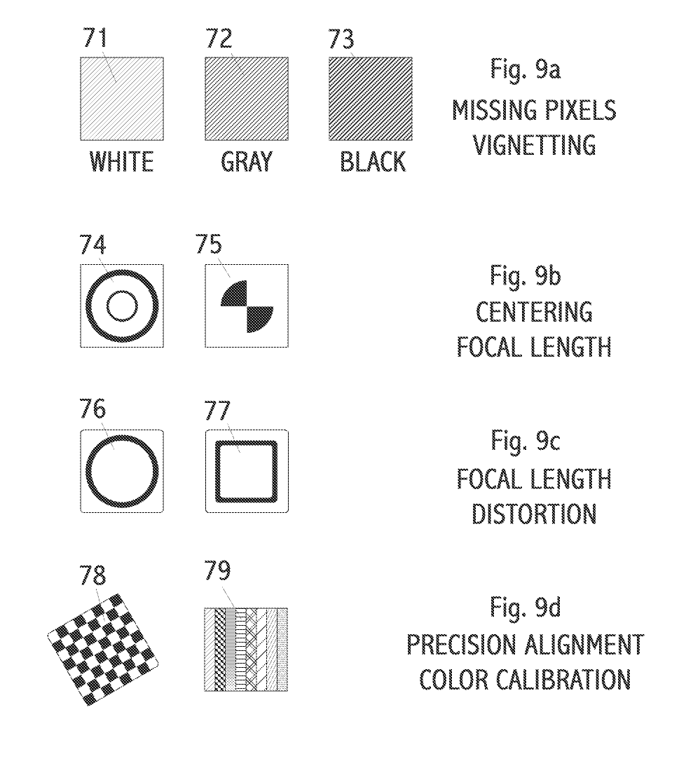

FIGS. 9a, 9b, 9c and 9d show exemplary targets used in the calibration steps. Although the order below is not absolutely required, there are significant benefits to performing the calibration steps in the stated order. Note that as the calibration sequence proceeds, each calibration step is used to correct or improve the data for the subsequent calibration steps. For example, once missing pixels are identified, those missing pixels are filled in with data from adjacent pixels for the subsequent calibration steps.

First, missing or error pixels are identified by imaging evenly lit targets of white 71, mid-gray 72, and black 73. The white and black targets should be close to by not entirely at the dynamic limits of the sensor. The target should be large enough to fill the entire sensor as imaged. A pixel be “stuck at white,” “stuck at black,” stuck at some other value, or may be floating and have an arbitrary value, as exemplary failure modes. These three targets find some, but not all defective pixels. In addition, these targets are used to create a map, down to the pixel level if desired, of the gain and/or offset difference of each pixel. In addition, the vignetting of the lens is measured, assuming that the targets are truly illuminated uniformly. We prefer to perform the vignette calibration later, but it is almost as effective if performed with these targets early in the process, which has the advantage of using fewer total target changes during the calibration sequence. These steps are performed for each lens/sensor pair individually.

Next, in FIG. 9b, each lens/sensor pair optical axis, or “center” is measured relative to the other lens/sensor pairs. One or more targets such as 74 or 75 are used for this purpose. Using a 2D-correlator, or other methods, the exact center of each lens/sensor pair is easily determined to sub-pixel resolution.

In addition, these targets are used to compute the exact focal-length of the lens. Target 74 is preferred for this use.

In FIG. 9c we see two targets, 76 and 77, either of which are used to measure the distortion of the lens, such as pincushion or barrel distortion. Ideally the distortion is measured and corrected algorithmically prior to any of the next calibration steps. Focal-length is ideally measured after correcting for distortion. 76 is the preferred target for measuring focal-length. Each lens/sensor should have its distortion and focal-length measured and corrected individually.

Next in FIG. 9d we use a precision target for fine-tuning alignment and other calibration adjustments. Here we see a checkerboard in 78. Typically the target would have many more squares than shown in this Figure. The checkerboard is turned to eliminate moiré and other interference patterns between the vertical/horizontal arrangement of pixels in the sensor array and the X-Y grid on the target 78. Due to the previous calibration steps, the checkerboard should be imaged quite precisely. This step is used to make fine adjustments of many calibration metrics. For example, a position-offset map is created for every pixel, or the sensor is divided into am exemplary 16×16 array of areas, and each area corrected separately. Typically adjustments at this level are sub-pixel. Pixels that produce a value in error then take on the value of a neighboring pixel, the computed, weighted average of neighboring pixels.

Finally, we use a target similar to 79 to adjust for color. 79 comprises strips of different, known colors. Standardized color palettes could also be used. The color range should include IR and UV, if these are spectral ranges are included in the camera's capabilities.

Although some of the calibration steps are performed in the prior art, they serve a different purpose for our camera because the combining of sub-image data from different lens/sensor pairs requires consistent, high-quality calibration. Such calibration needs are more precise and more comprehensive than required for prior art purposes.

Additional calibration, tests and quality control steps would be performed, as one trained in the art appreciates.

Calibration data is stored in flash memory, or in volatile or non-volatile memory in the camera, or in a remote memory accessible by the camera.

Data is stored and transferred uncompressed, in “raw” data format. Or, a standard lossless compression standard is be used, such as TIFF or PNG. Or, a lossy compression standard is used where key information is adequately preserved. For example, JPEG using the highest image quality parameters is very close to lossless in quality, but with significantly less storage required per image. Video compression is more computationally challenging. For example, both MPEG-4 and H.264 are video compression standards that were designed for expensive (studio-based) compressors but with low cost decompressors (consumer products). In this invention, we would prefer the opposite. That is: low cost (low computational requirements) compression in the camera, with high cost (higher computational requirements) in post-field processing. The typical processor power in a desk-top computer is not only readily available, but also it is far more powerful than the ultra-low power (to conserve battery life) processor in the camera. Therefore, a preferred embodiment for this invention is to use an intermediate video compression that achieves a lower compression ratio than, say MPEG4 or H.264, but requires far less computer power. Then post-field processing is used to re-compress the video for lower storage.

In one embodiment, the camera compresses high-resolution areas using higher quality compression parameters; while compressing low-resolution areas using lower quality compression parameters. High-resolution areas comprise sharp focus areas; low-resolution areas comprise out-of-focus areas. Similarly, high-resolution areas include automatically identified or manually identified areas of interest, such as faces, or a moving subject, or a subject selected by the user; while low-resolution areas comprise the remainder of the image area.

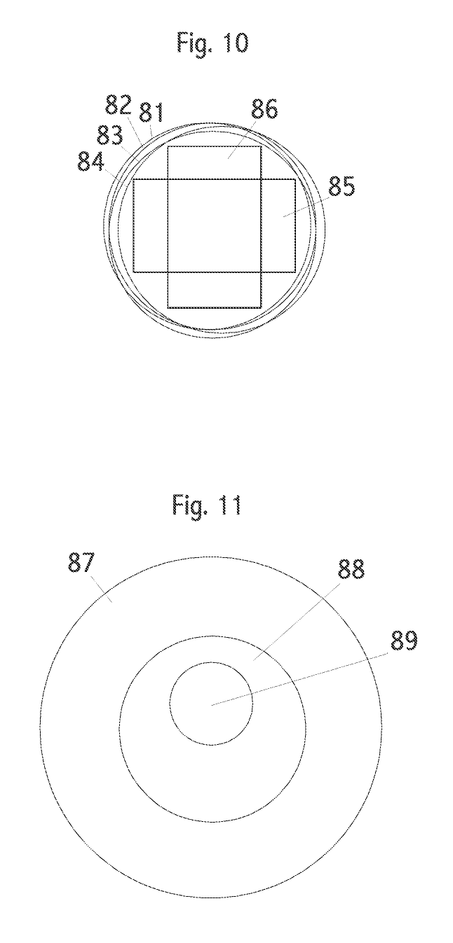

FIG. 10 shows, in another embodiment, how four lens/sensor pairs look at the same subject. Thus, the four circles representing the overlaid image areas of the four lens/sensor pairs, 81, 82, 83 and 84, are nearly co-incident. Ideally, they would typically be fully co-incident. They are shown slightly offset in this Figure, first for visibility in the Figure, but also to show how in manufacturing the four lens/sensor pairs are optically aligned. The calibration steps previously described are used so that the final image data is a proper combination of the sub-image data from the four lens/sensor pairs. 85 shows a typical landscape mode, horizontal aspect ratio, rectangular final image, as created from the four 81 through 84 sub-images. 86 shows a typical portrait mode, vertical aspect ratio, rectangular final image, as created from the four 81 through 84 sub-images. Note that in order to support both of these modes the four sensors in the 81 through 84 lens/sensor pairs must include as a minimum pixel sensors for both the 85 and 86 final image areas, plus any additional pixels needed above, below, left or right in order to allow for misalignment of the four 81 through 84 lens/sensor pairs.

FIG. 11 shows one embodiment using three different focal-length lenses looking at the same general subject. 87 is the largest circle, representing the image area of the subject in wide-angle view. 88 is the mid-sized circle, representing the “normal” focal-length view. 89 is the telephoto, or smallest circle. Note that these circles represent the area of the final image. In fact, the sensor sizes are, in many embodiments, different than the sizes of the circles in this Figure. The three sub-images represented by the three circles in FIG. 11 are combined into a single wide-angle image. Note, however, that that the two smaller circles provide higher resolution data towards the center of the subject. Note also, that although area 88 is centered in are 87, the telephoto area 89 is raised up from the center of 88. This vertical offset represents the typical position of most subjects. For example, people's heads, when taken with a normal focal-length lens 88, are typically in the top half of the image. This overlay of wide-angle, normal, and telephoto lenses looking at one subject allows most photographers to simply point and shoot at the subject, then decide what scope(s) and effect(s) they would like to use, preserve or share, later.

The camera has multiple storage options. The camera could, for example, create one very high-resolution image using the best possible resolution of 89, but with the image size of area 87. Alternatively, the camera could record three different images. Many other storage models are possible. Selection may be done prior to taking the photo, immediately after taking the photo, when the user of the camera optionally manually selects one or more final images to save, or much later, say, after the images have been downloaded from the camera.

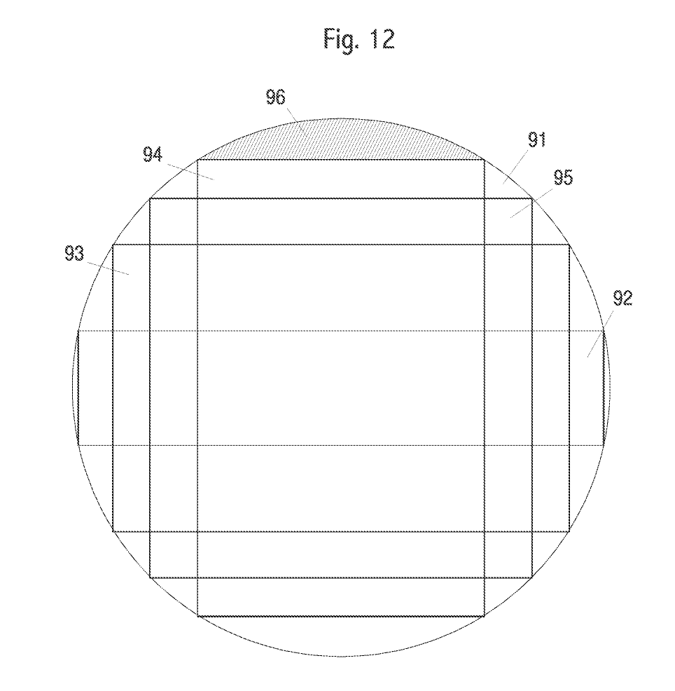

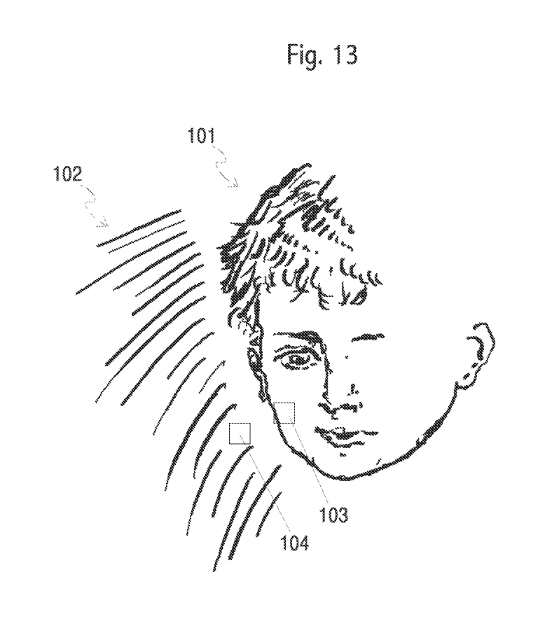

FIG. 12 shows different aspect ratio final images overlaid on a circular field. A lens creates a circular image area 91. The user may wish to have a panorama format 92. Or, the user may wish to have a traditional 3:2 landscape aspect ratio 93, or a portrait shape 94. Some people prefer a square format 95.

Considering all the possible image formats that people like, the minimum sensor pixels should be the combination of all these areas 92, 93, 94 and 95, as a minimum. For example, in the discussion so far, area 96, shown shaded, is not required. However, a very common failure of amateur photographers is to “cut the head off” their subject by aiming the camera too low. The desired and missing head may well have been imaged by the lens in area 96, but lost because there were no sensor pixels in that area. Thus, for this invention, in one embodiment, we place sensor pixels to pick up all of the image data, approximately circular, from the lenses. This permits “post click correction” of some photo problems. For example, the portrait mode area 94 may have “slid upward” into the area 96. The camera or image data holds this “hidden data,” not normally shown in a default, chosen image format (such as 94). However, when selecting a “correct” mode, some of these extra image pixels are used to correct certain problems, such as restoring some or all of the cut-off head. As the area 94 is “raised” to pick up some of the data from 96, the two top corners of the area 94 well become blank, as there is no image data to fill them. However, it is easy enough to manufacture credible data to fill the corners, typically by extending data already near the corner. Although not ideal, the salvaged image is preferable to a non-usable, headless image.

FIG. 13 shows a method of separating a foreground or desired image area from a background or undesired image area. 101, here a face, is the exemplary desired image area. 102 shows the background. Small pixel areas, 103 and 104 are analyzed to determine blurring. This invention provides superior distinction between foreground and background by the use of two or more lens/sensor pairs set to different focus distances taking sub-images at the same time. Although prior art may use the focus (blurring) of an area to determine foreground v. background, such computation from a single image generally has many errors, relative to what the observer of the photograph ideally considers desired (sharp) v. undesired (blurred) subject matter. In our invention, one such applicable algorithm is “differential blur detection.” In this algorithm, the blurring of two areas, such as 103 and 104 in the Figure are compared between one lens/sensor image, which we call A, and are focused closely to match the distance of the desired subject 101, and a second lens/sensor image, which we call B, and is focused at infinity or at a distance father away than A. B sub-images area 102 in the Figure. Area 103 is sharper in sub-image A than B. Area 104 is sharper in B than A. These variations in sharpness are sometimes be small. These variations are typically small compared to the variations in many other small areas of sub-images. Thus, the comparison of area between two differently focused lens/sensor sub-images is far more accurate at determining distance, and thus desired v. undesired subject area than comparisons of sharpness with a single prior art image.

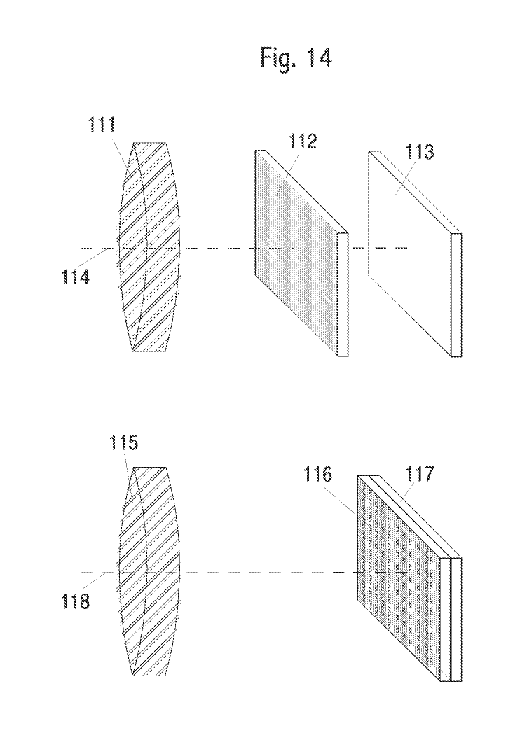

FIG. 14 shows two exemplary lens/sensor pairs. The first pair comprises lens 111 and sensor 113. Also shown is a spectral filter 112 in the optical path 114. In this lens/sensor embodiment, the filter 112 is not directly bonded or attached to either the lens 111 or the sensor 113. However, in other embodiments the filter 112 is bonded to the sensor 113 or the lens 111. For example, in the prior art RGB filters are frequently bonded to the sensor. Also, in the prior art IR blocking interference filters comprise coatings directly on the lens. Note that lens shapes, sensor shapes, and filter shapes, as well as the scale in FIG. 14 are not meant to be representative of actual shapes or scale. Shown also in FIG. 14 is a second exemplary lens/sensor pair comprising lens 115, sensor 117 and filter 116 in the optical path 118. The filter 116 is a different filter than filter 112. In the embodiment shown, filter 116 is bonded to sensor 117. The lenses 111 and 115, and the sensors 113 and 117, are identical or substantially different, depending on embodiment and the purpose of each lens/sensor pair. For example, filter 112 passes the color green while the filter 116 passes the color red. As another example, the filter 112 passes infrared, while the filter 116 passes ultra-violet light. Depending on embodiment, lenses are compound. Depending on embodiment, multiple filters are used in a single optical path.

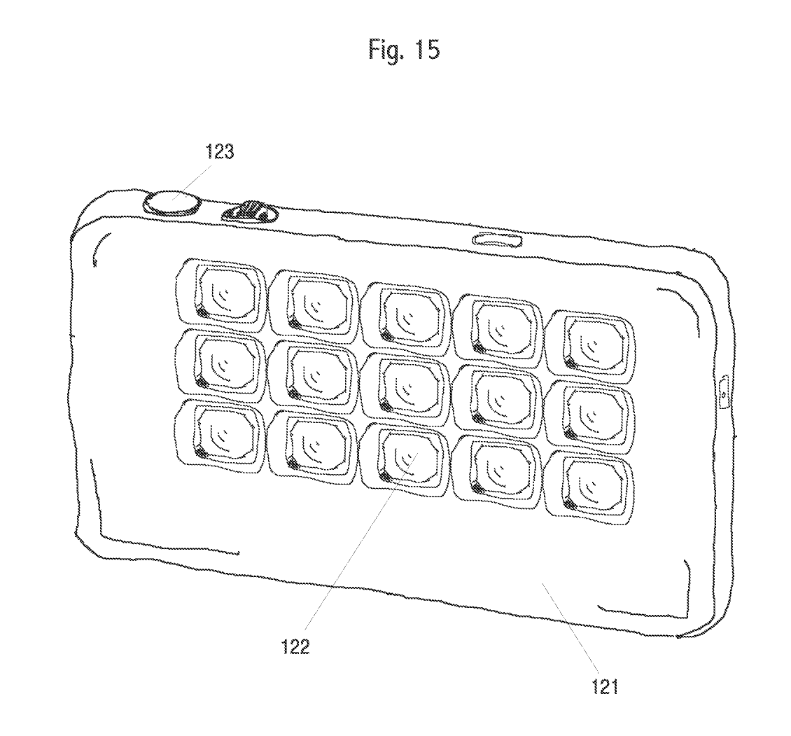

FIG. 15 shows one exemplary embodiment of the camera. In this embodiment, a lens array 122 of 5 by 3 lenses is implemented on a traditional flat “point-and-shoot” camera form factor. Button 123, traditionally called a “shutter-release” button on mechanical cameras, is depressed by the user to initiate a photo creation sequence within the camera. We refer to this as the “photo button.” The camera body 121 is shown. The sides and back of the camera contain other controls, accessories, and access ports, as well as a preview screen, in a typical embodiment. For example, embodiments of the camera include one or more: flash; electrical connector ports; storage card locations; wireless communication; mode control buttons; a touch screen; information display screen; mechanical accessory access points; covers or hinges; mechanical and or electrical interfaces to gang cameras. As one trained in the art appreciates, and as discussed herein, many variations of this invention exist as embodiments.

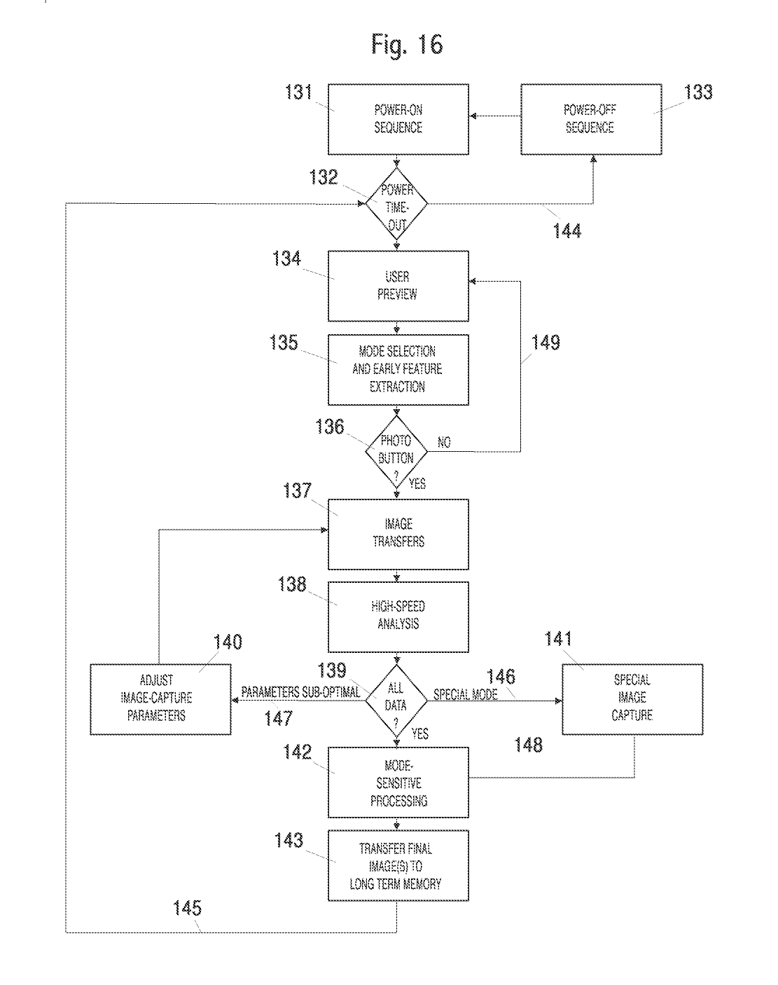

FIG. 16 shows one embodiment of a flow chart executed by the internal processor within the camera. The power-on sequence 131 is initiated when the user activates a power switch, or by other means. If the camera has not been used for a time, a power-time out decision 132 causes a power-off sequence 133 via path 144. The power-on sequence includes self-test, memory initiation, reading user controls, turning on display screens, activating wireless communication, and other electronic and software initialization. The power-off sequence includes graceful and appropriate termination of communications, turning off displays, updating non-volatile memory, and shutting down electronic and software processes. Following the power-on sequence user preview 134 is initiated. This step provides a real-time video preview for the user, based on the mode selected by the user, or the mode provided by the default setting for the camera, or a mode determined automatically by the camera. Step 135 provides the user with mode selection based on the features available for the particular embodiment of the camera. Early feature extraction includes for example: identifying faces for exposure and focus; focus over the field of view, recommendations by the camera to the user, and internal within the camera preparation for picture taking. This step includes dynamic processing of information from one or more sensors. Such pre-photo dynamic processing uses less than full-resolution data, in some embodiments.

Step 136 comprises initiating a photo sequence. This step is traditionally initiated by the user depressing a “shutter-release” button, herein called a “photo-button.” Other means of initiating a photo sequence are used in some embodiments, such a touching a touch-screen, or automatic operation based on a timer, proper focus, desired subject in the frame, motion or lack of motion in the frame or other means. For example, in fireworks mode, the camera will wait until fireworks have reached a pre-set brightness and field of view, and then initiate a photo sequence. In group portrait mode, the camera will wait until all subjects are facing the camera, and/or smiling, fully in the frame, and relatively motion-less, then initiate a photo sequence. In a sports mode, the camera will wait until a high-speed object, such as a ball, racquet, skier, or golf-club head enters an appropriate portion of the frame, and then initiate a photo sequence. In landscape mode, the camera will wait until the camera is held relatively still and is pointed appropriately at a landscape scene (such as level, with the horizon in the frame), then initiate a photo sequence. The multiple lens/sensor pairs in the camera are ideal for making the determinations discussed herein. Early feature extraction step 135 comprises these determinations, as well the option, either manually or automatically, of changing camera operational mode.

Until the photo sequence is initiated step 136, path 149 provides for continued preview 134 and optional mode changes 135.

Following 136 initiation of the photo sequence step 137 transfers data from the image sensors into working memory. Step 138 performs any analysis necessary to determine that all the necessary data is properly captured in order to create an appropriate final image or images. For example, fine focus is examined, as is exposure and framing. For this step 138 the processing is optimized for speed in order to make the necessary determination for step 139 quickly.

Step 139 is a three-way determination that correct and final data from the sensors has been obtained. This determination is responsive to both the mode as selected by the user manually or by the camera automatically, as well as the high-speed image analysis performed in step 138. If the data is appropriate step 142 is next. If data acquired is sub-optimal, such as improper exposure or other parameters one or more sensors are not set optimally 147 then step 140 is next. If a special mode is selected path 146 is followed to generate additional exposures step 141. Such special modes comprise a sequence of stills; a video sequence; a sequence for capturing a panorama; a sequence at different exposures to capture a wider dynamic range; a sequence to capture a motion-based subject, such as catching a ball; a sequence to capture an optimum image, such as minimum motion blur or an optimized sports image; a sequence to capture background unobstructed by a moving foreground object; or other sequences as necessary, appropriate, or desired depending on mode, user preference, dynamics of the subject, and embodiment.

If step 139 determines that image or images should be re-captured with different internal sensor parameters, step 140 adjusts responsively those parameters then returns to step 137 to recapture the primary image data for the final image. Step 138 is performed quickly so that if retaking the photo is necessary via step 140 that neither the camera position, nor typically the subject position, has shifted substantially from the location that existed at step 136.

Step 142 then performs the necessary image processing steps software and electronics as discussed herein to create the final image or images. For example, this step combines sub-images from multiple lens/sensor pairs into a final image. This step 142 is performed in the camera or in post-field processing. Following step 142 the final image or images are transferred to long-term memory, which is flash, a memory module, data in the cloud, data on a post-field processor, or other long-term non-volatile memory. Step 142 includes data from other cameras and includes transferring data to other cameras or other devices, as discussed herein, in some embodiments. Step 142 is performed by distributed processing computational or programmable elements, based on embodiment.

Following step 143 via path 145 the camera is again ready to take another picture.

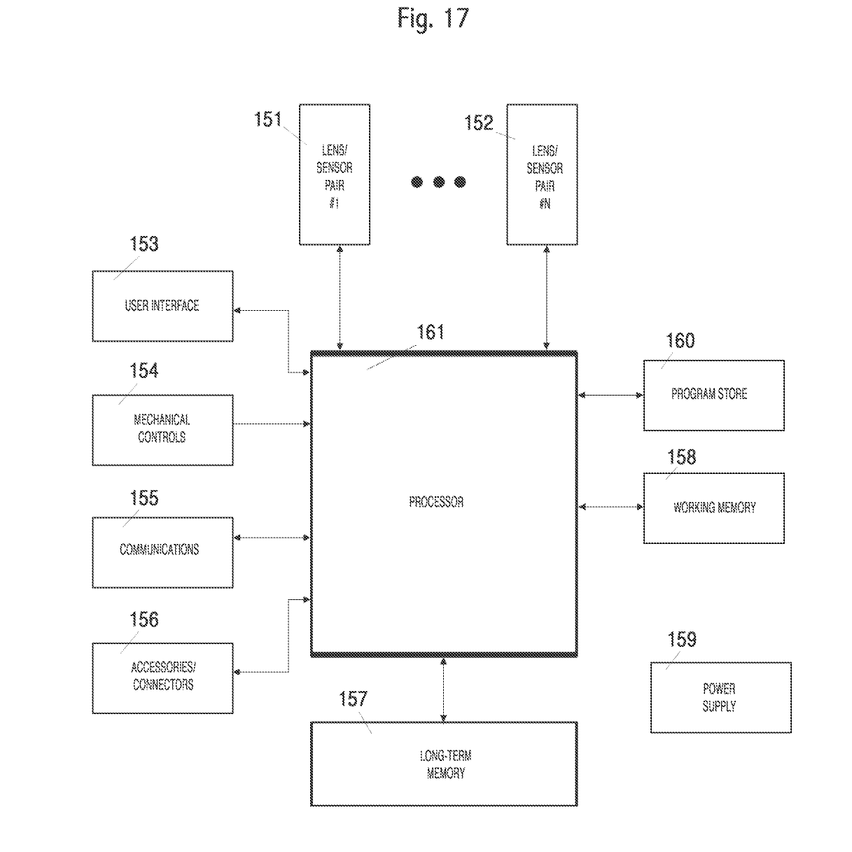

FIG. 17 shows a block diagram of the camera, in one embodiment. 151 and 152 are two shown of N lens/sensor pairs, which connect to the processor 161, which executes from its program store 160 the firmware to implement the in-camera steps as described herein for the operation of the camera. The user interface 153 includes a preview screen and any other output devices, display and user input devices or sensors. Mechanical controls are shown in 154, such as mechanical power switches and mechanical buttons or knobs. Communications 155 includes wireless communications and infrared send and receive capability. Communications also occur via a cable in some embodiments. 156 includes electronic accessories, such as connectors to other cameras, other programmable or electronic devices, and removable storage and communications modules. Working memory, typically RAM, for the processor is shown in 158. Long-term storage is shown in 157, which is internal flash memory, a memory module, or memory accessed via a communications channel. 159 is the power supply which supplies power to all electronic modules and components. The program store 160 is ROM, flash or other means to hold the instructions for the processor 161. This memory is shared with the long-term memory 157 in some embodiments.

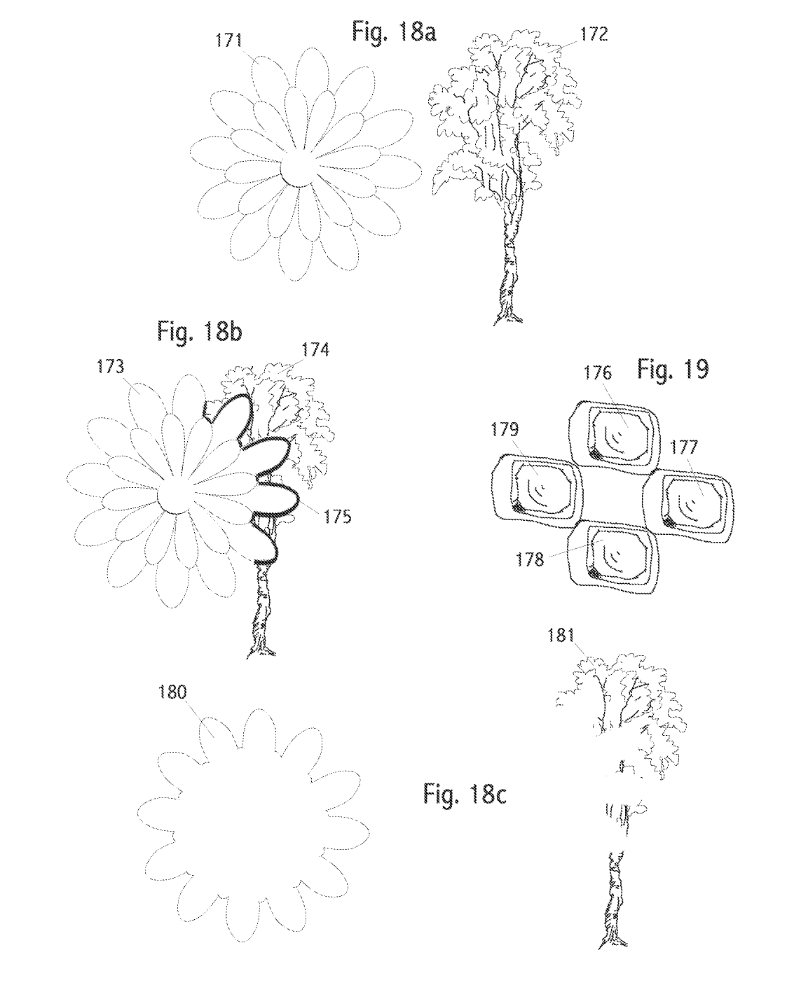

FIGS. 18a, 18b and 18c show steps in the process of identifying and isolating foreground and background subject in a photograph using this invention. FIG. 19 shows one embodiment of multiple lens/sensor pairs used for this particular example. 176 and 178 are a vertically aligned pair of lens/sensor pairs whose sub-images are capable of differentiating between foreground and background objects at a horizontal border due to the vertical parallax of the two lenses. 177 and 179 are a horizontally aligned pair of lens/sensor pairs whose sub-images are capable of differentiating between foreground and background objects at a vertical border due to the horizontal parallax of the two lenses. In other embodiments, three lenses, rather than four, are used, with appropriate changes to the algorithm relating to the different geometry of the lenses. Similarly, more than four lenses are used in some embodiments. FIG. 18a shows two objects, a foreground flower 171 and a background tree 172. Here, the two objects are shown separately for convenience of this description. The sub-images from the lenses shown in FIG. 18b show portions of the flower 173 in front of portions of the tree 174. The sub-images from lens/sensor pairs 177 and 179 are compared, using 2D correlation, for example. The differences between the two sub-images due to parallax identify a border between the near flower 173 and the distant tree 174 along roughly vertical sections of the flower petals. The sub-images from lens/sensor pairs 176 and 178 are compared, using 2D correlation, for example. The differences between the two sub-images due to parallax identify a border between the near flower 173 and the distant tree 174 along roughly horizontal sections of the flower petals. The areas of sub-image differences are then summed, producing an area shown in FIG. 18b as a dark outline 175. The direction of the image shifts from the parallax identify which side of the border 175 is foreground and which side of the border is background. In FIG. 18b, only the border where the flower 173 overlaps the tree 174 is shown. Additional borders for the flower 173 with other background objects are also identified in the same way. Additional borders for other foreground objects are also identified.

For some objects this algorithm will not generate a complete and accurate outline of the object. The outline of the flower, in this example, if further enhanced by the use of line-following around the complete edge of the flower. The parameters of the line-following algorithm, for example, the yellow color of the flower petals, the darker background, and the sharpness and curvature of the flower petals edges, are used to complete the outline of the foreground flower 173. In addition, as necessary, color, brightness, saturation, texture and noise are also considered to identify the flower portions of the sub-images.

The tree 174 is identified as being on the other side of the identified border area 175 from the flower 173. The tree, at a middle distance has a large amount of high-spatial-frequency information. In addition, the tree branches and leaves have many holes through which information from more distant objects, such as mountains or sky, show through. These two factors make correlation between the tree and other, more distance objects difficult to do accurately. However, portions of the tree 174 near the border 175 are well identified by the proximity to the border. The tree is characterized by its color, brightness, saturation, texture and noise. These five parameters are used to identify the areas within the sub-images that are in fact, “tree.” Thus, the tree is fully isolated in the image by these five characteristics.

We see in FIG. 18c the results of the identification of the flower, now 180 and the isolated portion of the tree, now 181. The outlines as determined by the above algorithm are used as masks for one or more sub-masks to create a result, final photograph containing only the flower or the portion of the tree that is visible. Similarly, each identified object, such as the flower 180 and the tree 181 are treated differently in the combined image. For example, the sharpest and best-exposed flower is combined with the sharpest and best-exposed tree where in each case different lens/sensor pairs were used to generate the respective used sub-images. As another example, the background tree is intentionally blurred additionally (more blurred than from any sub-image) prior to combining for a desired photographic effect. As another example, the isolated flower and the isolated tree portion are provided to the user as two separate final photographs. A photographic encoding format that includes a z-axis, “mask,” such as TIFF or PNG is used to provide both the object information pixels and the effective mask information for that object. Note that as shown in FIGS. 18a and 18b the flower is complete 171 and 173, whereas in FIG. 18c the flower 180 is shown as an outline, or mask, of the flower.

There are multiple features that are implemented once the near image area is identified as distinct from far image area. For example, color correction is be applied differently to the two areas in one embodiment. Alternatively, the undesired areas are removed completely, or substituted in the final image. In one embodiment of this invention the background image areas are blurred additionally, while the desired subject areas are overlaid on top of the blurred background. This creates an effect similar to or even better than the “blurred background” desired effect used in portrait photography that in prior art required a large-aperture lens with a low depth of field.

This invention has the advantage that it has a deeper depth of field for the subject than prior art large-aperture lenses, yet produces the same blurred background desired effect on the final image.

In some embodiments multiple cameras are capable of operating either as independent cameras, or linked together to operate as a single camera. In one embodiment multiple cameras “snap together,” forming a mechanical fit to create a single mechanical and electronic “ganged camera.” Two cameras gang, side by side, or cameras, in another embodiment, extend to a large number in either a linear or two-dimensional array. In yet another embodiment multiple cameras remain mechanically separate, but are linked electronically with one or more electronic cables. In yet another embodiment the cameras are linked with a wireless connection, such as 802.11n, Bluetooth or cellular, (or one of many other radio or optical networking protocols). When so ganged by any of these methods, the features, options and embodiments described herein are available using lens/sensor pairs from multiple cameras in the gang. Such ganging is used, for example to: (a) gain resolution, (b) gain wider angle for panorama, (c) gain additional depth, stereoscopic, 3D or 2.5D information, (d) work around undesirable objects in the foreground to capture more of the background or middle-ground subject.

In one application of the above embodiment, consider a family on vacation. Each member of the family, say five people, has his or her own camera. However, if desired, any number of these cameras are ganged for additional capability.

In another application of the above embodiment, consider a busload of affiliated tourists. Each tourist has a single camera hanging on his or her chest by a neck strap. However, as any one of the tourists (or one or more photographic leaders) takes a picture with her camera, all of the cameras for all of the affiliated tourists take a picture at the same time. Then, either using field processing or post-field processing, the capabilities of all lens/sensor pairs are combined. This allows, for example, for very large, high resolution images of say, the inside of a church to be created, with portions of the final image based on what each individual tourist is facing at the moment the photograph is taken. Such an application would allow a 3D “virtual church” to be reconstructed using the combined optical data captured from all of the affiliated tourists.

In yet another application of the above embodiment, consider a wedding photographer. The photographer places a number of individual cameras around the event venue. Then, as the photographer takes a picture, a much wider fraction of the venue as captured at that moment, such as the bride coming down the isle, when all faces are turned, or as the groom kisses the bride, when all faces have a smile.

In yet another application of the above embodiment, consider sports photography, where multiple static (or mobile) cameras capture action from significantly different angles, at the same moment.

A novel aspect of this invention in this embodiment is that the individual cameras operate either as stand-alone cameras or as part of gang, based on the wishes of the user or users in the field.

### DEFINITIONS

Use of the words, “may,” “could,” “option,” “optional,” “mode,” “alternative,” and “feature,” when used in the context of describing this invention, refer specifically to various embodiments of this invention. All descriptions herein are non-limiting, as one trained in the art will appreciate.

Use of the words, “ideal,” “ideally,” “optimum,” and “preferred,” when used in the context of describing this invention, refer specifically a best mode for one or more embodiments for one or more applications of this invention. Such best modes are non-limiting, and may not be the best mode for all embodiments, applications, or implementation technologies, as one trained in the art will appreciate.

A “lens-sensor pair” is sometimes called a “sub-camera.” Such a sub-camera comprises a lens, and image sensor, and processing circuitry to create generate a digital image from the sensor and storage to hold the digital image. The processing circuitry and storage are be shared with other sub-cameras in some embodiments.

“Post-field processing” refers to some manipulation of image data in an environment distinct from real-time processing within the camera. For example a user may take photographs “in the field” then manually or automatically perform post-field processing of the stored or transmitted image in his office.

What is claimed is:

1. A camera comprising a plurality of lens/sensor pairs;
each lens configured to provide a sub-image on the corresponding sensor in the lens/sensor pair; the corresponding sensor configured to provide a corresponding sub-image data set;
calibration data, for each lens/sensor pair, comprising the relative optical axis of each lens/sensor pair;
software configured to combine sub-image data from a plurality of lens/sensor pairs, responsive to the calibration data, to form a final digital image, wherein the software is in non-transitory memory;
storage means configured to store digital image data.

2. The camera of claim 1 wherein the calibration data additionally comprises a map of bad pixels.

3. The camera of claim 1 wherein a first lens/sensor pair additionally comprises a optical filter that passes light of a first spectra, and wherein a second lens/sensor pair additionally comprises a optical filter that passes light of a second spectra.

4. The camera of claim 1 wherein a first lens/sensor pair additionally comprises a optical filter that passes light of a first spectra; and wherein a second lens/sensor pair additionally comprises a optical filter that passes light of a second spectra; and wherein a third lens/sensor pair additionally comprises a optical filter that passes light of a third spectra; and wherein the first, second and third spectra comprise light of red, green and blue light respectively.

5. The camera of claim 1 wherein a first lens/sensor pair additional comprises a optical filter that passes light of a first spectra, and wherein a second lens/sensor pair additionally comprises a optical filter that passes light of a second spectra; and wherein the first spectra comprises visible light and the second spectra comprises infrared light; and wherein the final image comprises data from both the first lens/sensor pair and the second lens/sensor pair.

6. The camera of claim 1 wherein the lens in a first lens/sensor pair comprises a first focal-length and the wherein the lens in a second lens/sensor pair comprises a second focal-length, and the second focal-length is numerically higher than the first focal-length; and wherein the optical field of view of the second lens is contained with the optical field of view of the first lens; and wherein the final image comprises data from both the first lens/sensor pair and the second lens/sensor pair.

7. The camera of claim 1 wherein the lens in a first lens/sensor pair comprises a first focal-length and the wherein the lens in a second lens/sensor pair comprises a second focal-length, and the second focal-length is numerically higher than the first focal-length; and wherein the optical field of view of the second lens is contained with the optical field of view of the first lens; and wherein the camera further comprises a means for a user of the camera to select a final image whose field of view is substantially similar to the field of view of the first lens or to select a final image whose field of view is substantially similar to the field of view of the second lens.

8. The camera of claim 1 wherein:
a first lens of a first lens/sensor pair has a first field of view;
a second lens in a second lens/sensor pair has a second field of view;
a third lens in a third lens/sensor pair has a third field of view;
the first field of view overlaps the second field of view;
the second field of view overlaps the third field of view;
the first field of view does not overlap the third field of view;
the final image data comprises sub-image data from the first and the second and the third lens/sensor pairs;
the final image data comprises a substantially continuous image.

9. The camera of claim 1 wherein:
a first lens of a first lens/sensor pair has a first focus distance and a first field of view;
a second lens in a second lens/sensor pair has a second focus distance and a second field of view;
the first field of view overlaps the second field of view;
the first and the second focus distances are different;
the final image data comprises sub-image data from the first and the second lens/sensor pairs;
the final image data comprises a substantially continuous image, wherein individual final pixels are selected to come from the first sub-image or the second sub-image responsive to the relative sharpness of the area surrounding the corresponding individual pixels in the first and the second sub-images.

10. The camera of claim 1 wherein:
a first lens/sensor pair additionally comprises a first optical filter that passes a first spectra;
a second lens/sensor pair additionally comprises a second optical filter that passes a second spectra;
the first and second spectra are different;
the first lens/sensor pair generates a first set of sub-image data;
the second lens/sensor pair generates a second set of sub-image data;
both the first lens of the first lens/sensor pair and the second lens of the second lens/sensor pair are free from one or more chromatic aberration correction elements that would be required in an alternative single lens to focus light of both the first spectra and the second spectra to produce an image with the same sharpness as the average sharpness of the images created responsive to the first and second sets of sub-image data.

11. The camera of claim 1 wherein:
a plurality of lens/sensor pairs are aggregated into a panorama set;
each lens/sensor pair in the panorama set comprises an optical axis;
the optical axis of each lens/sensor pair in the panorama set is non-parallel to the optical axis of all other lens/sensor pairs in the panorama set;
the field of view of each lens/sensor pair in the panorama set overlaps with the field of view of at least one other lens/sensor pair in the panorama set;
each lens/sensor pair in the panorama set generates sub-image data from a panorama exposure wherein each panorama exposure occurs at the same time for each lens/sensor pair in the panorama set;
the sub-image data from the panorama exposures are merged responsive to the calibration data for the lens/sensor pairs in the panorama set to create a final continuous panorama image wherein all picture elements in the final continuous panorama image are exposed at the same time.

12. The camera of claim 11 wherein:
the responsive merging of sub-image data from a first number of lens/sensor pairs responsive to perspective variation between the different sub-images wherein the perspective variation of the final continuous panorama image is comparable to that of a merged panorama image created from at least twice as many uncorrected sub-images as the first number.

13. A method of taking a photograph using the camera wherein the camera comprises a plurality of lens/sensor pairs; and each lens is configured to provide a sub-image on the corresponding sensor in the lens/sensor pair; the corresponding sensor configured to provide a corresponding sub-image data set; wherein the steps comprise:
calibrating, comprising storing the relative optical axis of each lens/sensor pair;
photo-taking, wherein a user of the camera initiates a picture taking sequence within the camera; the photo-taking sequence comprising:
generating an optical sub-image on the sensor in the each lens/pair using the lens in each lens/sensor pair;
generating a digital sub-image data corresponding to the optical sub-image for each lens/sensor pair;
correcting the digital sub-image data of said each sensor responsive to the calibration data stored for lens/sensor pair for that sensor;
combining the corrected digital sub-image data into a final digital image;
storing the final digital image.

14. The method of claim 13 with the further limitation:
the camera further comprises:
a first lens/sensor pair focused at a first distance;
a second lens/sensor pair focused at a second distance;
the first and second lens/sensor pairs comprise overlapping field of views;
the picture-taking step further comprises: both the first and the second lens/sensor pair take an exposure at the same time;
the second generating step further comprises:
the first lens/sensor pair generates a first set of sub-image data;
the second lens/sensor pair generates a second set of sub-image data;
an additional comparing step between the correcting step and the combining step wherein the sharpness of an image area A in the first set of sub-image data with the sharpness of the same image area A in the second set of sub-image data;
an additional selection step after the comparing step wherein either the image area A from the first set of sub-image data or image area A from the second-set of sub-image data is selected;
the comparing and selection steps are repeated for additional image areas;
the combining step further comprises merging the image areas selected in the comparing and selection steps into a final image data set.

15. The method of claim 14 comprising the additional step, prior to the combining step, of:
performing an image-processing algorithm on the digital sub-image data from at least one lens/sensor pair.

16. The method of claim 15 wherein the image-processing algorithm is a blurring algorithm.

17. A method of manufacturing a camera comprising a plurality of lens/sensor pairs wherein:
each lens is configured to provide a sub-image on the corresponding sensor in the lens/sensor pair; the corresponding sensor configured to provide a corresponding sub-image data set;
calibration data, for each lens/sensor pair, comprising the relative optical axis of each lens/sensor pair;
software configured to combine sub-image data from a plurality of lens/sensor pairs, responsive to the calibration data, to form a final digital image;
storage means configured to store digital image data;
wherein at least two of the lenses in the at least two lens/sensor pairs are formed as single piece.

18. The method of claim 17 wherein:
the camera further comprises a lens substrate designed to accept at least two insertable lenses of the lens/sensor pairs wherein the substrate is configured to position the insertable lenses in the proper optical position.

19. The method of claim 18 wherein:
the camera further comprises a monolithic sensor sheet further comprising the sensors of at least two lens/sensor pairs.

20. A method of taking a photograph using a camera comprising a plurality of lens/sensor pairs, wherein the camera comprises:
each lens in the lens/sensor pairs configured to provide a sub-image on the corresponding sensor in the lens/sensor pair; the corresponding sensor configured to provide a corresponding sub-image data set;
calibration data, for each lens/sensor pair, comprising the relative optical axis of each lens/sensor pair;
software configured to combine sub-image data from a plurality of lens/sensor pairs, responsive to the calibration data, to form a final digital image;
storage means configured to store digital image data;
at least one IR lens/sensor pair configured to focus and use light in the infrared spectrum;
wherein the steps of the method comprise:
initiating a picture-taking sequence by the user of the camera;
turning on an infrared illuminator;
creating an exposure using the IR lens/sensor pair using the light generated by the infrared illuminator; wherein the IR lens/sensor pair generates an IR sub-image data set; while at the same time creating an exposure from a second lens/sensor pair using visible light; wherein the second lens/sensor pair generates a visible sub-image data set;
turning off the infrared illuminator;
correcting the IR sub-image data set responsive to the calibration data stored for IR lens/sensor pair and correcting the visible light sub-image data set responsive to the calibration data stored for the visible lens/sensor pair;
combining the corrected IR sub-image data set with the corrected visible light sub-image data set into a final continuous color image;
storing the final continuous color image.
